(19) United States
(12) Patent Application Publication
(10) Pub. No.: US 2023/0141203 A1
(43) Pub. Date: May 11, 2023

(54) BIODEGRADABLE CANDLE DESIGNS AND METHODS OF MANUFACTURE

(71) Applicant: Panthera Candleworks, LLC., Columbus, IN (US)

(72) Inventors: Renata Marcela Nunez, Columbus, IN (US); Juan Diego Rincon-Nunez, Columbus, IN (US)

(73) Assignee: Panthera Candleworks, LLC., Columbus, IN (US)

(21) Appl. No.: 17/522,360

(22) Filed: Nov. 9, 2021

(51) Int. Cl. C11C 5/02; C11C 5/00

(52) U.S. Cl. CPC C11C 5/023; C11C 5/006; C11C 5/002

(57) ABSTRACT

Candles and methods of making the same where the materials used in making the candles are all biodegradable and/or compostable. Candles which include a candle body vessel made from bamboo and filled with a wax or combinations of waxes which are selected for their ability to adhere to bamboo, the remains of which may be disposed of via composting once the candles have reached the end of their useful life.

### TECHNICAL FIELD

The present disclosure relates generally to candle design and manufacture.

### BACKGROUND

Candles are commonly used for decorative purposes when unlit as well as for providing illumination and in many formulations pleasing aromas when lit. Typical candle design uses a wax body which may or may not be contained within a vessel and at least one wick embedded in the wax body. The wax body may be scented or unscented. The materials used in the production of many candles, however, may be environmentally problematic. Wax bodies made from petroleum-based paraffin both use an unsustainable source material in addition to producing potentially toxic byproducts when burned. Many of the substances used to provide scents in modern candles are also made from unsustainable and/or synthetic materials which produce potentially toxic byproducts during combustion. Even the non-combustible components of many candles may be environmentally problematic. Wicks are typically secured to a candle body using a metal ring which is commonly thrown away when the candle is fully consumed. Even if a vessel which holds the wax body is made from a recyclable material it is also frequently simply thrown away. These shortcomings of modern candle design and manufacture result in candles which use unsustainable resources to manufacture, produce potentially toxic air pollution when used, and leave behind waste once consumed that must be landfilled. It is evident that there is a continuing need for candle designs which use only sustainably sourced, biodegradable materials.

### SUMMARY OF THE INVENTION

In one aspect, a candle design having a vessel with an upper body wall portion and a base portion defining a candle body volume, a wick fixably mounted to the vessel within the candle body volume by a securing plug, and a wax disposed within the candle body volume and surrounding at least a portion of the wick, where the vessel, wick, securing plug, and wax are all made from biodegradable and/or compostable materials. In one example the vessel is made from bamboo and the wax or combination of waxes used to make the candle are selected at least in part for their ability to adhere to bamboo. Such waxes include, but are not limited to, those made at least in part from coconut oils and include one or more of coco apricot crème, hemp coco soy, and combinations thereof. Optionally the waxes may include one or more fragrance compounds. The wicks may be made from cotton or wood and the securing plug from naturally occurring clays. In still other aspects, the bamboo vessel is coated with one or more layers of a flame retardant compound such as flame retardant compounds containing melamine.

### BRIEF DESCRIPTION OF THE DRAWINGS

FIG. 1 is a partial cross sectional view of a candle according to one embodiment;

FIG. 2 is perspective view of candle body vessels according to one embodiment;

FIG. 3 is a perspective view of a candle according to one embodiment;

FIG. 4 is a perspective view of a candle according to one embodiment; and

FIG. 5 is a partial cross sectional view of a candle according to another embodiment.

### DETAILED DESCRIPTION

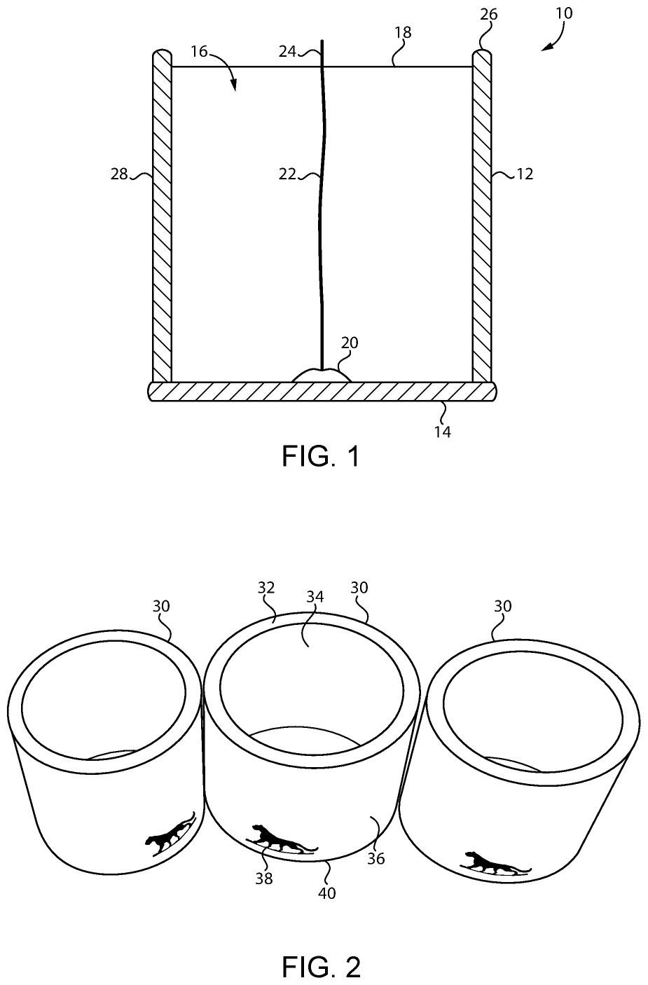

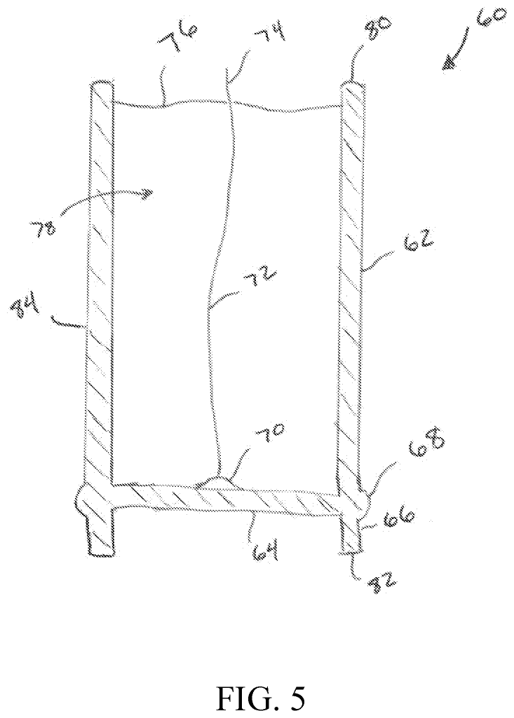

A partial cross sectional view of a candle 10 according to one embodiment is shown in FIG. 1. In this particular example candle body vessel 12 having a cylindrical upper portion 28 and a substantially flat base portion 14 define a candle body volume 16. In one embodiment, the flat base portion 14 may be a node structure which occurs in bamboo such as shown in greater detail in FIG. 5. The upper edge 26 of the cylindrical upper portion 28 of the candle body vessel 12 has been worked to produce a rounded edge. In other examples the upper edge may be worked to produce other profiles such as chamfers, bullnoses, bevels, and the like. The candle body vessel 12 is made from a material which is sustainably produced as well as fully biodegradable and/or compostable. In one example the candle body is made from bamboo which typically composts within 6 months. Within the candle body volume 16 a wick 22 is secured to the candle vessel 12 using a securing plug 20 and the volume 16 filled with wax 18 to the desired level until a tip 24 of the wick 22 remains above the wax level 18.

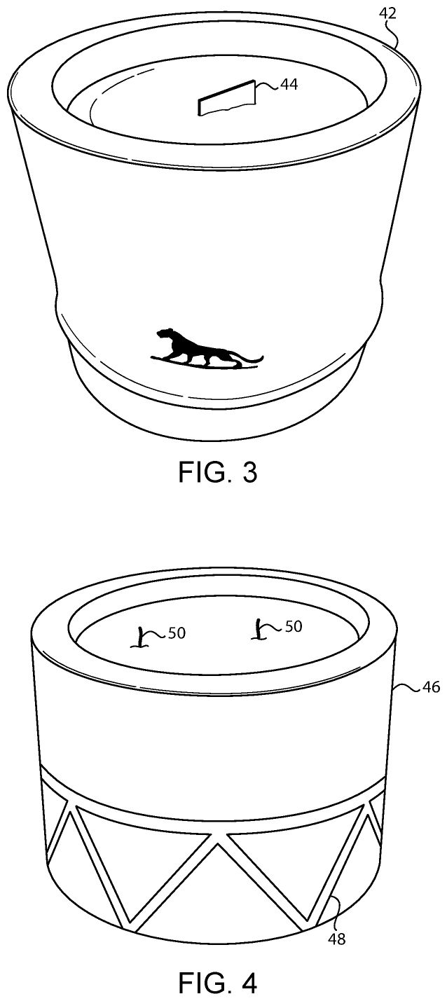

Candles such as those described herein may be manufactured by first selecting and preparing a candle body vessel 30 such as those shown in FIG. 2. In this example, bamboo chutes are selected according to the desired diameter of the finished candle then cut to a desired length. The upper 32 and lower 40 ends are then shaped and finished to produce a desired edge profile. For example, the lower end 40 may be cut flat and then sanded whereas the upper end 32 may be given a more decorative finish such as a bevel and then sanded or polished to remove any rough portions. Once the bamboo vessel is cut and shaped to the desired length and profile decorative features 38 may be added to the exterior surface 36. The exact nature and scope of the decorative features may vary as desired. In this particular example, the profile of a large cat has been branded to the exterior surface 36 using a heated branding iron. In other examples other patterns, words, images, and the like may be added.

After any desired decorations are added to the vessel they are treated with one or more applications of a suitable flame retardant substance. In one example, the flame retardant substance is non-toxic, eco-friendly, and/or is sustainably produced. Such flame retardant substances include melamine compounds (one example of which is sold under the name Flamecheck M-111 by Flamecheck® International, LLC of Tucson, Ariz., USA) which typically work by insulating a coated substance from heat as well as evolving nitrogen gas when burned or charred which inhibits further combustion. One or more coats of a suitable fire retardant substance are applied evenly to all surfaces of the candle body vessel 30 including the upper edge 32, lower edge 40, exterior surface 36, and interior surface 34. Suitable application methods may include spray, brushing, dipping, and the like.

Once one or more applications of the flame retardant material have been applied and have dried or cured the candle may be constructed within the prepared candle vessel. First, a wick is set within the candle vessel body. The wick may be made from a variety of different sustainable, natural, and/or biodegradable materials including cotton or raw wood. Optionally raw wood wicks may be fabricated such that they produce an audible “crackling” sound when burned or they may be silent when burned. The amount and intensity of wick “crackle” may be controlled by the species of wood used, the moisture level in the wood, and the wax used in the candle. The wick is set by attaching it to the candle vessel within the vessel body using natural clay (which is fully compostable) rather than the traditional metal plate (which is not biodegradable or compostable). Once the wick is set the candle vessel body may be filled with wax. A variety of sustainably produced and biodegradable and/or compostable waxes may be used. In one example, the wax is selected at least in part for its ability to adhere to the bamboo of the candle vessel body. Natural waxes such as pure beeswax and palm oil wax which might be sustainably produced and biodegradable and/or compostable adhere to bamboo poorly which results in an unstable candle. Suitable waxes include, but are not limited to, coconut apricot crème (coco apricot crème), hemp coconut soy (hemp coco soy), and combinations thereof. Optionally one or more fragrance compounds may be added to the wax prior to casting a candle. In one particular example fragrance compounds are made from sustainably sourced materials and may be all natural, non-toxic, and/or fully biodegradable/compostable. The exact ratio of fragrance compound to wax may vary as desired. Typically fragrance is added up to 12% by weight, but more or less fragrance compound may be added depending on the characteristics of the wax used in a particular candle. Once any fragrance compounds have been added to the melted wax, the wax may be poured into the prepared candle vessel body to the desired level and allowed to cool. Once cooled the candle is finished and ready for use. Candles produced using these techniques are clean burning, producing minimal toxic byproducts when burned, and contain only biodegradable and/or compostable materials. Once the candle has reached the end of its useful life the remaining components (the vessel body, securing plug, and residual portions of the wick and/or wax) may be composted or recycled using normal means.

The previously described method may be used to produce variations of the candle shown in FIG. 1, which has a candle 42 having a wooden wick 44 as shown in FIG. 3. Optionally, a candle 46 having more than one wick 50 may also be produced as seen in FIG. 4. In this particular example the candle 46 also includes a decorative pattern 48 on the outer surface. Other patterns, symbols, lettering, and the like may also be burned, etched, carved, or otherwise produced on the outer surface of candles.

A partial cross sectional view of a candle 60 according to another embodiment is shown in FIG. 5. In this particular example candle body vessel 62 having a cylindrical upper portion 84, a cylindrical lower portion 66, and a substantially flat base portion 64 define a candle body volume 78. In this particular example, the flat base portion 64 is a node structure 68 which occurs in bamboo and divides the cylindrical upper portion 84 and the cylindrical lower portion 66. The upper edge 80 of the cylindrical upper portion 84 of the candle body vessel 62 has been worked to produce a rounded edge. The lower edge 82 of the lower cylindrical portion 66 has been worked to produce a flat edge which acts as a stable base for the candle 60. In other examples the edges may be worked to produce other profiles such as chamfers, bullnoses, bevels, and the like. The candle body vessel 62 in this example is made from a bamboo material which is sustainably produced as well as fully biodegradable and/or compostable. Within the candle body volume 78 a wick 72 is secured to the candle vessel 62 using a securing plug 70 and the volume 78 filled with wax 76 to the desired level until a tip 74 of the wick 72 remains above the wax level 76.

The exact length of the cylindrical upper portion and a cylindrical lower portion may vary as desired. Bamboo canes or stems are generally hollow, but are solid at nodes as shown in FIG. 5. By selecting a bamboo cane having a particular diameter and cutting the selected cane at particular locations along the internode length of the cane, a candle vessel having a desired length of cylindrical upper portion length and cylindrical lower portion length may be produced. Optionally, the cylindrical lower portion may be eliminated by cutting the bamboo at or near the node and machining or working the piece until the base portion is substantially flat leaving no cylindrical lower portion.

The present description is for illustrative purposes only and should not be construed to narrow the breadth of the present disclosure in any way. Thus, those skilled in the art will appreciate that nigh-infinite modifications might be made to the presently disclosed embodiments without departing from the full and fair scope and spirit of the present disclosure. Other aspects, features, and advantages may be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A biodegradable candle comprising:
a bamboo vessel having an upper body wall portion and base portion defining a candle body volume;
a wick fixably mounted to the vessel within the candle body volume by a securing plug; and
a wax disposed within the candle body volume and surrounding at least a portion of the wick;
wherein the base portion is a bamboo node
wherein the wick, securing plug and wax are all made from biodegradable and/or compostable materials.

2. The biodegradable candle of claim 1, wherein the wax is adherable to bamboo.

3. The biodegradable candle of claim 2, wherein the wax is made at least in part from coconut oils.

4. The biodegradable candle of claim 3, wherein the wax is coco apricot crème, hemp coco soy, and combinations thereof.

5. The biodegradable candle of claim 1, wherein the securing plug is made of natural clay.

6. The biodegradable candle of claim 1, wherein the wick is made from cotton or wood.

7. The biodegradable candle of claim 1 further comprising a second wick fixably mounted to the vessel within the candle body volume by a second securing plug.

8. The biodegradable candle of claim 1 wherein the wax includes least one fragrance compound.

9. The biodegradable candle of claim 1 wherein the vessel is coated with at least one layer of a flame retardant compound.

10. The biodegradable candle of claim 9, wherein the flame retardant compound includes melamine.

11. A biodegradable candle comprising:
a vessel having an upper body wall portion and a lower body wall portion divided by a base portion, the upper body wall portion and base portion defining a candle body volume;
a wick fixably mounted to the vessel within the candle body volume by a securing plug; and
a wax disposed within the candle body volume and surrounding at least a portion of the wick;
wherein the base portion is a bamboo node and the upper body wall portion and lower body wall portion are internodal lengths of bamboo;
wherein the wick, securing plug and wax are all made from biodegradable and/or compostable materials.

12. (canceled)

13. A biodegradable candle comprising:
a vessel having an upper body wall portion and a lower body wall portion divided by a base portion, the base portion being a naturally occurring bamboo node between the upper body wall portion and the lower body wall portion, the upper body wall portion and base portion defining a candle body volume;
a wick fixably mounted to the vessel within the candle body volume by a securing plug; and
a wax disposed within the candle body volume and surrounding at least a portion of the wick;
wherein the vessel, wick, securing plug and wax are all made from biodegradable and/or compostable materials.

14. The biodegradable candle of claim 13, wherein the vessel is made from bamboo and the wax is adherable to bamboo.

15. The biodegradable candle of claim 13, wherein the securing plug is made of natural clay.

16. The biodegradable candle of claim 13 wherein the vessel is coated with at least one layer of a flame retardant compound.

17. The biodegradable candle of claim 16, wherein the flame retardant compound includes melamine.
